(19) United States
(12) Patent Application Publication
(10) Pub. No.: US 2010/0110231 A1
(43) Pub. Date: May 6, 2010

(54) OUTPUT CONTROL CIRCUIT AND IMAGING DEVICE

(75) Inventor: Masami Funabashi, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/595,786

(22) PCT Filed: Jan. 22, 2008
(86) PCT No.: PCT/JP2008/050828

§ 371 Date: Oct. 13, 2009

(30) Foreign Application Priority Data
Apr. 13, 2007 (JP) 2007-106274

(51) Int. Cl. H04N 9/68; H03K 5/08

(52) U.S. Cl. 348/234; 327/321; 348/E09.054; 348/300

(57) ABSTRACT

A storage section (101) stores a digital value. A compensation section (102) controls an offset value of an amplifier circuit (2) according to the digital value stored in the storage section (101). A determination section (103) determines whether the voltage value of an output signal (S2) from the amplifier circuit (2) is higher or lower than a reference voltage value. An adjustment section (104) adds a positive value to the digital value in the storage section (101) if the number of times the voltage value of the output signal is determined higher than the reference voltage value among k determination results by the determination section (103) is greater than the number of times the voltage value of the output signal is determined lower than the reference voltage value. Contrarily, the adjustment section (104) adds a negative value to the digital value in the storage section (101) if the number of times the voltage value of the output signal is determined lower than the reference voltage value is greater than the number of times the voltage value of the output signal is determined higher than the reference voltage value.

### TECHNICAL FIELD

The present invention relates to a circuit for controlling the input/output characteristics of an offset-adjustable amplifier circuit, and more particularly, to a clamp circuit mounted in an imaging device.

### BACKGROUND ART

An imaging device is conventionally equipped with an image sensor circuit for converting an image of a subject to an electric signal and a correlated double sampling circuit for extracting a luminance component of the image from the electric signal. The imaging device is also equipped with a clamp circuit to ensure extraction of the luminance component of the image of the subject with high precision. The clamp circuit controls the input/output characteristics of the correlated double sampling circuit so that the voltage value of an analog signal outputted from the correlated double sampling circuit is a desired value when an electric signal corresponding to an optical black pixel formed on the imaging plane of the imaging sensor circuit is inputted into the correlated double sampling circuit.

Such a clamp circuit is disclosed in Japanese Patent Gazette No. 2942055 (Patent Document 1), Japanese Laid-Open Patent Publication No. 2002-232741 (Patent Document 2), and the like. In Patent Document 1, a differential voltage between the output of a differential amplifier circuit and a reference voltage is generated and fed back to the differential amplifier circuit, to thereby control the output of the differential amplifier circuit. In Patent Document 2, an analog signal from an amplifier circuit is converted to a digital signal, differential data between the digital signal and a reference digital value is obtained, and an analog signal having a voltage value corresponding to the differential data is fed back to the amplifier circuit, to thereby control the output of the amplifier circuit. As in these cases, the output of an amplifier circuit is conventionally controlled based on the difference between the output signal from the amplifier circuit and a reference voltage.

### Patent Document 1: Japanese Patent Gazette No. 2942055

### Patent Document 2: Japanese Laid-Open Patent Publication No. 2002-232741

### DISCLOSURE OF THE INVENTION

### Problems to be Solved by the Invention

However, a noise component is superimposed on the output signal from an amplifier circuit, and hence the difference between the output signal and a reference voltage contains the noise component. In particular, when a pixel defect such as a white defect (a pixel in a state where the voltage value of its electric signal is saturated at any time) and a black defect (a pixel in a state where no electric signal is outputted at any time) exists in an image sensor circuit, the voltage value of the output signal greatly fluctuates. If the noise component is fed back to the amplifier circuit, the voltage value of a control signal for controlling the output of the amplifier circuit changes, causing unnecessary fluctuation in the voltage value of the output signal from the amplifier circuit. As this noise component is greater, the fluctuation amount of the voltage value of the output signal becomes greater. Conventionally, therefore, the voltage value of the output signal is not stable under the influence of the noise component. Hence, it takes extra time to allow the voltage value of the output signal to converge to a desired value. Moreover, even after having converged to a desired value, the voltage value of the output signal fluctuates deviating from the desired value.

As another problem, in the conventional clamp circuit, an integrator circuit is formed of a capacitance element and a resistance element, and the time constant of the integrator circuit is fixed. Therefore, it is difficult to shorten the time (converging time) required for the voltage value of the output signal to converge to a desired value. Also, for making the time constant of the integrator circuit adjustable, the circuit scale must be increased. Even if the capacitance element and the resistance element are provided externally, the number of components required during LSI mounting will increase, making it difficult to adapt a module to size reduction and cost reduction.

In view of the above, an object of the present invention is to improve the resistance to noise and reduce the circuit scale.

### Means for Solving the Problems

According to one aspect of the invention, the output control circuit is a circuit for controlling input/output characteristics of an amplifier circuit having an offset voltage that is adjustable, including: a storage section configured to store a digital value for determining a compensation amount for the offset voltage; a compensation section configured to reduce the voltage value of the offset voltage of the amplifier circuit as the digital value stored in the storage section increases; a determination section configured to determine whether the voltage value of an output signal from the amplifier circuit is higher or lower than a reference voltage value; and an adjustment section configured to, once receiving k determination results (k is a natural number equal to or more than 2) by the determination section, add a positive value to the digital value stored in the storage section if the number of times the voltage value of the output signal is determined higher than the reference voltage value among the k determination results is greater than the number of times the voltage value of the output signal is determined lower than the reference voltage value, and add a negative value to the digital value stored in the storage section if the number of times the voltage value of the output signal is determined lower than the reference voltage value is greater than the number of times the voltage value of the output signal is determined higher than the reference voltage value.

In the output control circuit described above, in which whether the output value of the output signal is higher or lower than the reference voltage value is determined, the determination results are not affected by the differential amount between the voltage value of the output signal and the reference voltage value. Hence, the fluctuation of the voltage value of the output signal is prevented from increasing according to the magnitude of a noise component. Also, since the offset voltage of the amplifier circuit is compensated based on a plurality of determination results, an influence of a sporadic noise can be removed. It is therefore possible to improve the resistance to a noise component, and hence suppress unnecessary increase/decrease of the output of the amplifier circuit due to a noise component. Moreover, since it is unnecessary to provide an integrator circuit made of an analog circuit, unlike the conventional case, the circuit scale can be reduced.

According to another aspect of the invention, the imaging device includes: a first image sensor circuit having an imaging plane with a plurality of light-receiving pixels and a plurality of optical black pixels formed thereon, the first image sensor converting an image of a subject to an electric signal; a correlated double sampling circuit having an offset voltage that is adjustable, the correlated double sampling circuit extracting an analog signal representing a luminance signal from the electric signal obtained by the first image sensor circuit; an amplifier circuit configured to amplify the analog signal from the correlated double sampling circuit; an analog/digital converter circuit configured to convert the analog signal amplified by the amplifier circuit to a digital signal; a digital processing circuit configured to perform digital processing for the digital signal obtained by the analog/digital converter circuit; and the output control circuit described above. The output control circuit is a clamp circuit configured to control the input/output characteristics of the correlated double sampling circuit, the determination section determines whether the voltage value of an analog signal corresponding to the optical black pixel, in the analog signal from the correlated double sampling circuit, is higher or lower than the reference voltage value; and the compensation section compensates the offset voltage of the correlated double sampling circuit.

In the imaging device described above, it is possible to improve the resistance to a noise component, and hence suppress unnecessary fluctuation in the voltage value of the analog signal. Accordingly, the correlated double sampling circuit can extract the analog signal representing a luminance signal with high precision, and hence the precision of the imaging device can be improved.

In the imaging device described above, the determination section may determine whether the voltage value of an analog signal corresponding to the optical black pixel, in the analog signal from the amplifier circuit, is higher or lower than the reference voltage value, and the compensation section may compensate the offset voltage of the correlated double sampling circuit.

### EFFECT OF THE INVENTION

As described above, the resistance to a noise component can be improved. Also, since it is unnecessary to provide an integrator circuit made of an analog circuit, unlike the conventional case, the circuit scale can be reduced.

### BRIEF DESCRIPTION OF THE DRAWINGS

FIG. 1 is a block diagram showing a configuration of a clamp circuit of Embodiment 1 of the present invention.

FIG. 2 is a signal waveform diagram for demonstrating the operation of the clamp circuit shown in FIG. 1.

FIG. 3 is a signal waveform diagram for demonstrating the operation of a clamp circuit of Embodiment 2 of the present invention.

FIG. 4 is a signal waveform diagram for demonstrating the processing by a determination section in Embodiment 3 of the present invention.

FIG. 5 is a view showing a configuration of the determination section in Embodiment 3 of the present invention.

FIG. 6 is a signal waveform diagram for demonstrating the processing by comparators and the processing by a result processing portion in FIG. 5.

FIG. 7 is a signal waveform diagram for demonstrating the processing by a determination section in Embodiment 4 of the present invention.

FIG. 8 is a signal waveform diagram for demonstrating the processing by a determination section in Embodiment 5 of the present invention.

FIG. 9 is a view for demonstrating the processing by an adjustment section in Embodiment 5 of the present invention.

FIG. 10 is a view showing an alteration of the operation of the clamp circuit shown in FIG. 1.

FIG. 11 is a block diagram for demonstrating an example of compensation of the offset voltage of a correlated double sampling circuit based on an analog signal from a gain control circuit.

FIG. 12 is a block diagram of an imaging device equipped with a plurality of image sensor circuits.

### DESCRIPTION OF CHARACTERS

1 Image sensor circuit
2 Correlated double sampling circuit
3 Gain control amplifier circuit
4 Analog/digital converter circuit
5 Digital processing circuit
6 Selection circuit
11 Clamp circuit
12 Reference voltage generation circuit
13 Control circuit
101 Storage section
102 Compensation section
103 Determination section
104 Adjustment section
105 Setting section
201a, 201b, 201c Comparator
202 Result processing portion

### BEST MODE FOR CARRYING OUT THE INVENTION

Hereinafter, embodiments of the present invention will be described in detail with reference to the relevant drawings. Note that identical or equivalent components are denoted by the same reference numerals, and description thereof is not repeated.

### Embodiment 1

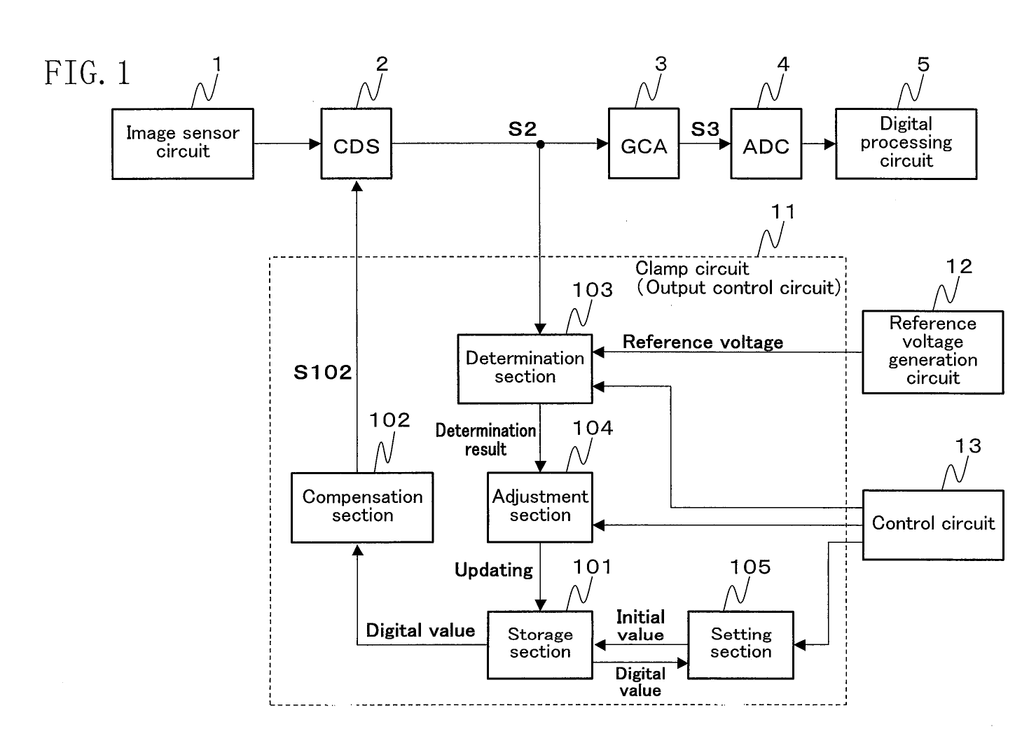

FIG. 1 shows a configuration of an output control circuit of Embodiment 1 of the present invention. The output control circuit is mounted in an imaging device as a clamp circuit 11. The imaging device includes an image sensor circuit 1, a correlated double sampling (CDS) circuit 2, a gain control amplifier (GCA) circuit 3, an analog/digital converter (ADC) circuit 4, a digital processing circuit 5, a reference voltage generation circuit 12, and a control circuit 13, in addition to the clamp circuit 11.

The image sensor circuit 1 photoelectrically converts an image of a subject to an electric signal. A plurality of light-receiving pixels are arranged in a matrix on the imaging plane of the image sensor circuit 1, and a plurality of optical black (OB) pixels are placed on the periphery of the imaging plane. The OB pixels are pixels each having a light-shading filter formed to prevent incidence of light. The correlated double sampling circuit 2 performs correlated double sampling for the electric signal from the image sensor circuit 1, to extract an analog signal S2 representing the luminance component from the pixel arranged on the imaging plane of the image sensor 1. Also, the correlated double sampling circuit 2 has an offset voltage, which is adjustable with a signal (compensation signal S102) from outside. The gain control amplifier circuit 3 amplifies the analog signal S2 from the correlated double sampling circuit 2. The amplification factor (gain) of the gain control amplifier circuit 3 is variable. The analog/digital converter circuit 4 converts an analog signal S3 from the gain control amplifier circuit 3 to a digital signal. The digital processing circuit 5 performs digital processing for the digital signal obtained by the analog/digital converter circuit 4. The reference voltage generation circuit 12 supplies a reference voltage to the clamp circuit 11. The control circuit 13 controls the operation of the clamp circuit 11.

The clamp circuit 11 controls the input/output characteristics of the correlated is double sampling circuit 2 so that the luminance component of an image captured by the image sensor circuit can be extracted as the analog signal with high precision. Specifically, the clamp circuit 11 compensates the offset voltage of the correlated double sampling circuit 2 so that the analog signal S2 outputted from the correlated double sampling circuit 2 is a desired value (e.g., the reference voltage value) when a black level signal (electric signal corresponding to the OB pixel of the image sensor circuit 1), which serves as the reference of the luminance component, is inputted into the correlated double sampling circuit 2. The clamp circuit 11 includes a storage section 101, a compensation section 102, a determination section 103, an adjustment section 104, and a setting section 105.

The storage section 101 stores a digital value, which is a value determining the compensation value for the offset voltage of the correlated double sampling circuit 2.

The compensation section 102, which is a digital/analog converter circuit, for example, supplies the compensation signal S102 to the correlated double sampling circuit 2 according to the digital value stored in the storage section 102 in such a manner that the voltage value of the compensation signal S102 is higher as the digital value is greater. In the correlated double sampling circuit 2, the voltage value of the offset voltage decreases by the equivalent of the compensation signal S102; i.e., as the voltage value of the compensation signal S102 is higher, the voltage value of the offset voltage is lower. In other words, the compensation section 102 reduces the voltage value of the offset voltage of the correlated double sampling circuit 2 as the digital value stored in the storage section 101 increases.

The determination section 103, which is a comparator, for example, receives the analog signal S2 from the correlated double sampling circuit 2 and the reference voltage from the reference voltage generation circuit 12, and outputs “H” if determining that the is voltage value of the analog signal S2 is higher than the voltage value of the reference voltage (reference voltage value) and “L” if determining that the voltage value of the analog signal S2 is lower than the reference voltage value. The reference voltage value corresponds to a desired voltage value of the analog signal S2.

The adjustment section 104 receives the determination results from the determination section 103 sequentially and accumulates the results. Once receiving k (k is a natural number equal to 2 or more) determination results, the adjustment section 104 adds a positive value (e.g., “+1”) or a negative value (e.g., “−1”) to the digital value stored in the storage section 101 according to the k determination results. Specifically, the adjustment section 104 adds a positive value to the digital value if the “H” count among the k determination results is greater than the “L” count. On the contrary, the adjustment section 104 adds a negative value to the digital value if the “L” count among the k determination results is greater than the “H” count. The “H” count as used herein refers to the number of times the voltage value of the analog signal S2 is determined higher than the reference voltage value, and the “L” count refers to the number of times the voltage value of the analog signal S2 is determined lower than the reference voltage value. When the “H” count and the “L” count are the same, the adjustment section 104 may add either a positive value or a negative value. Otherwise, the adjustment section 104 may be configured not to update the digital value.

The setting section 105, which is a register, for example, stores the initial value of the digital value. The initial value is preferably the digital value obtained when the voltage value of the analog signal S2 is a desired value (or a value near the desired value). The setting section 105 sets the digital value stored in the storage section 101 at this initial value under the control of the control circuit 13. For example, at the start of power supply to the clamp circuit 11, the setting section 105 performs this initial value setting.

The setting section 105 also reads the digital value stored in the storage section 101 under the control of the control section 13 and stores the read digital value therein as the initial value (i.e., updates the initial value). For example, the setting section 105 updates the initial value immediately before stop of the power supply to the clamp circuit 11.

The control circuit 13 controls the drive states of the determination section 103 and the adjustment section 104 in addition to controlling the setting section 105. Specifically, the control circuit 13 supplies a clamp pulse to the determination section 103 and the adjustment section 104 to drive these sections 103 and 104 for the time period during which the black level signal is being inputted into the correlated double sampling circuit 2 (black level signal input period), and stops the supply of the clamp pulse to stop the driving of the determination section 103 and the adjustment section 104 for the time period during which no black level signal is being inputted.

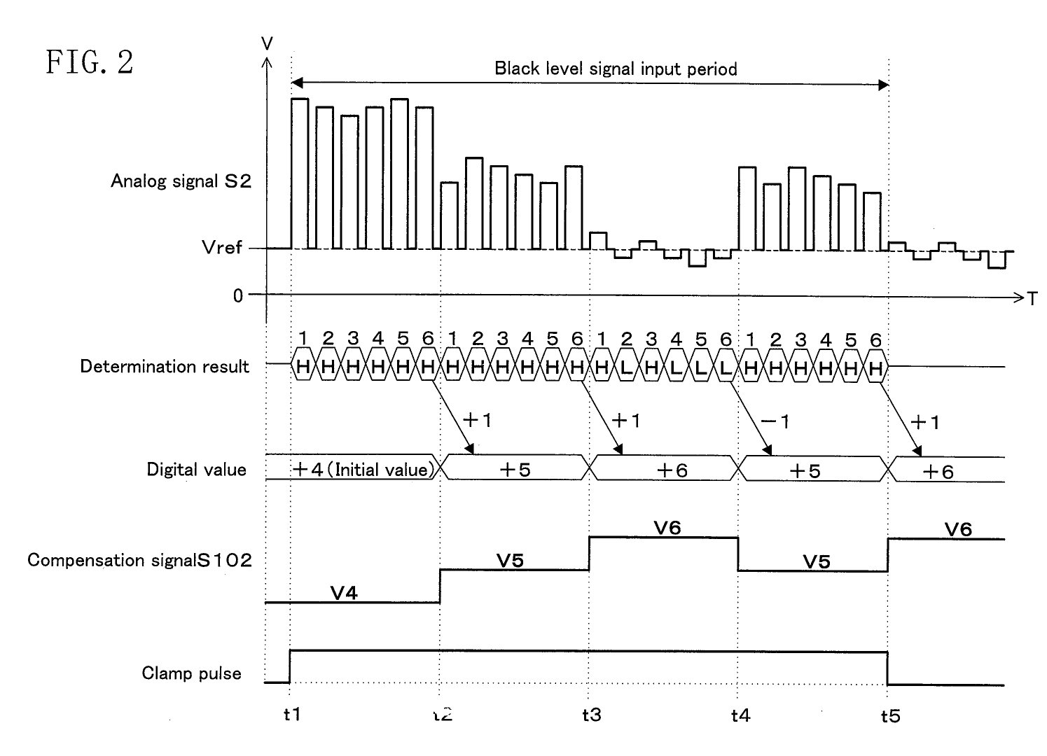

The analog signal S2 outputted from the correlated double sampling circuit 2 will be described. The analog signal S2 includes a noise component in addition to the offset voltage of the correlated double sampling circuit 2. Therefore, the voltage value of the analog signal S2 increases/decreases even during the black level signal input period as shown in FIG. 2. Examples of the noise component include a noise originating from the image sensor circuit such as a white defect and a black defect, an external noise generated adjacent to the correlated double sampling circuit 2, a noise inside the correlated double sampling circuit 2, and the like.

Next, referring to FIG. 2, the operation of the clamp circuit 11 shown in FIG. 1 will be described. Assume that the digital value stored in the storage section 101 is set at “+4” and the voltage value of the compensation signal S102 is set at “V4” corresponding to the digital value “+4.” Assume also that the adjustment section 104 updates the digital value every six times of determination by the determination section 103.

At time t1, a clamp pulse is supplied, to allow the determination section 103 and the adjustment section 104 to start driving. During time t1 to t2, the difference between the voltage value of the analog signal S2 and the reference voltage value Vref is greater than the fluctuation amount of the analog signal due to a noise component, and hence the determination results by the determination section 103 are stable. With the determination results by the determination section 103 being “HHHHHH”, the adjustment section 104 adds “+1” to the digital value stored in the storage section 101. With this addition, the digital value stored in the storage section changes from “+4” to “+5”, increasing the voltage value of the compensation signal S102 from “V4” to “V5”. This reduces the voltage value of the offset voltage of the correlated double sampling circuit 2, and hence reduces the voltage value of the analog signal S2.

Likewise, during time t2 to t3, the determination results by the determination section 103 are also “HHHHHH”. Hence, the digital value stored in the storage section 101 increases from “+5” to “+6”, increasing the voltage value of the compensation signal S102 from “V5” to “V6”. This further reduces the voltage value of the offset voltage of the correlated double sampling circuit 2.

During time t3 to t4, during which the voltage value of the analog signal S2 is near the reference voltage value Vref, the fluctuation in the analog signal S2 due to a noise component is no more negligible, and hence the determination results by the determination section 103 become unstable. With the “L” count among the six determination results by the determination section 103 being greater than the “H” count, the adjustment section 104 adds “−1” to the digital value stored in the storage section 101. With this addition, the digital value stored in the storage section 101 becomes “+5,” reducing the voltage value of the compensation signal S102 from “V6” to “V5.” This increases the voltage value of the offset voltage of the correlated double sampling circuit 2.

During time t4 to t5, the determination results by the determination section 103 are “HHHHHH”. Hence, the digital value stored in the storage section 101 changes to “+6,” and this reduces the voltage value of the offset voltage of the correlated double sampling circuit 2. At time t5, the supply of the clock pulse is stopped, terminating the processing by the determination section 103 and the processing by the adjustment section 104.

As described above, the determination results by the determination section are not affected by the differential amount between the voltage value of the analog signal and the reference voltage value. Hence, the fluctuation amount of the voltage value of the analog signal is prevented from increasing according to the magnitude of the noise component. Also, with the updating of the digital value based on a plurality of determination results, an influence of a sporadic noise can be removed. It is therefore possible to improve the resistance to a noise component, and hence suppress the output of the correlated double sampling circuit from unnecessarily increasing/decreasing due to a noise component. Accordingly, the time required for the voltage value of the analog signal to converge to a desired value during the clamping can be shortened, and once having converged, the voltage value of the analog signal can be made less easy to shift from the desired value.

Moreover, since it is unnecessary to provide an integrator circuit made of an analog circuit, unlike the conventional case, the circuit area of the clamp circuit can be reduced compared with the conventional case.

In addition, the digital value for determining the compensation amount for the offset value can be set at an arbitrary initial value, and hence by setting the initial value at an appropriate value, the converging time can further be shortened. For example, if the digital value observed when the voltage value of the analog signal is a desired value is known in advance, the digital value stored in the storage section may be set at this value, and this can omit the processing of adjusting the digital value.

Also, conventionally, when the clamp circuit is put in a halt state, the signal for controlling the output of the amplifier circuit is lost. Hence, once the clamp circuit resumes its drive state from the halt state, the control signal must be regenerated from the start. In this embodiment, however, the setting section reads out the digital value adjusted by the adjustment section before the clamp circuit enters the halt state. Hence, after the clamp circuit resumes its drive state from the halt state, the digital value stored in the storage section can be reset to the original digital value obtained before the halt state. This widely shortens the converging time at the time of resumption of the clamp circuit, compared with the conventional case, and hence permits frequent ON/OFF switching of the clamp circuit and also power reduction of the clamp circuit.

In the clamp circuit shown in FIG. 1, a quantization error occurs at the time of conversion of the digital value to the compensation signal in the compensation section 102. The quantization error is superimposed on the analog signal S2 from the correlated double sampling circuit 2 and transferred to the digital processing circuit 5 via the gain control amplifier circuit 3 and the analog/digital converter circuit 4. If the quantization error in the compensation section 102 has a certain degree of magnitude, a phenomenon (called ringing) occurs in which the voltage value of the analog signal S2 repeatedly increases/decreases near the reference voltage value failing to converge to the reference voltage value. If the fluctuation range of the analog signal S2 due to this ringing is smaller than the LSB in the analog-digital converter circuit 4, the digital processing will be performed normally in the digital processing section 5. However, if the fluctuation range of the analog signal due to the ringing is greater than the LSB, the resolution of the compensation section 102 should be improved to reduce the quantization error.

### Embodiment 2

The clamp circuit 11 of Embodiment 2 of the present invention is the same in configuration as that shown in FIG. 1, but is different therefrom in the processing by the adjustment section 104. In the clamp circuit 11 of this embodiment, the adjustment section 104 adds a positive value to the digital value stored in the storage section 101 if the “H” count among the k determination results is equal to or more than n (n>(k/2)), and adds a negative value to the digital value stored in the storage section 101 if the “L” count among the k determination results is equal to or more than m (m>(k/2)). Also, the adjustment section 104 does not update the digital value stored in the storage section 101 if the “H” count among the k determination results is smaller than n and the “L” count is smaller than m.

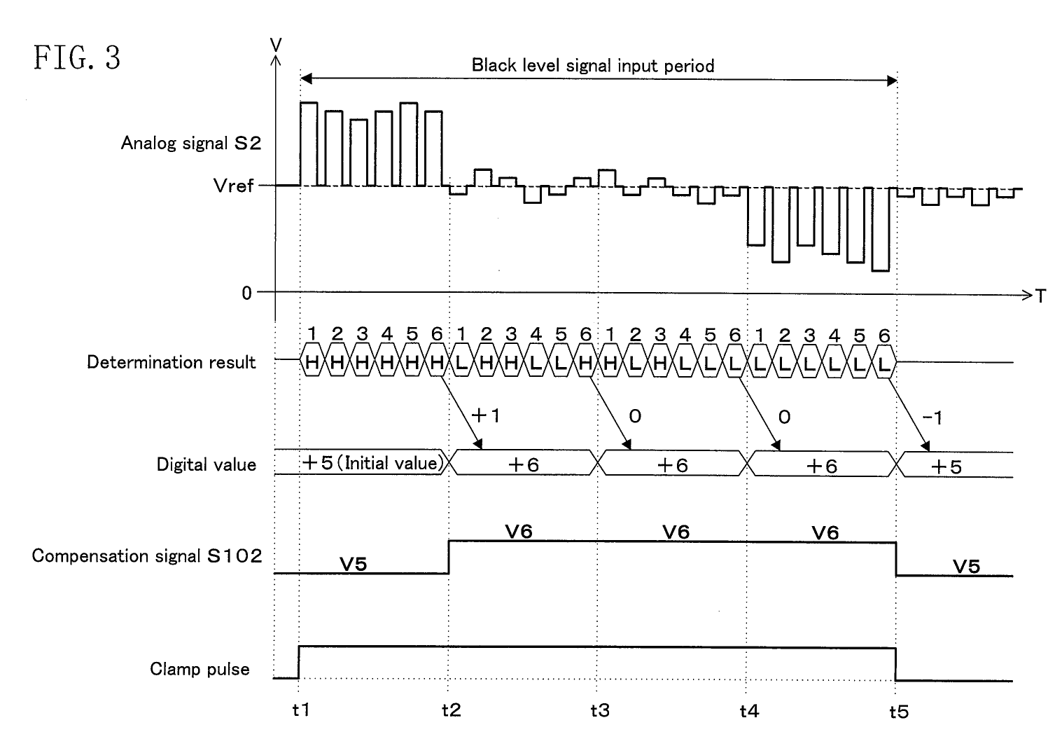

Referring to FIG. 3, the operation of the clamp circuit 11 of this embodiment will be described. Assume herein that k=6, n=6, and m=6.

During time t2 to t3, the voltage value of the analog signal S2 is near the reference voltage value Vref, and hence the determination results by the determination section 103 are unstable. With both the “H” count and the “L” count among the six determination results being smaller than “6”, the adjustment section 104 does not update the digital value stored in the storage section 101. Hence, the voltage value of the compensation signal S102 does not change, leaving the voltage value of the offset voltage of the correlated double sampling circuit 2 unchanged with no increase/decrease. During time t3 to t4, also, both the “H” count and the “L” count among the six determination results by the determination section 103 are smaller than “6”, and hence the digital value is not updated.

Assume that at time t4, the voltage value of the offset voltage of the correlated double sampling circuit 2 decreased because the surrounding environment of the correlated double sampling circuit 2 fluctuated (e.g., the electric signal corresponding to the OB pixels in the image sensor circuit 1 was affected by a temperature change or a power supply fluctuation). In this case, with the decrease in the voltage value of the offset voltage, the voltage value of the analog signal S2 also decreases, resulting in being apart from the reference voltage value Vref. During time t4 to t5, therefore, the determination results by the determination section 103 are “LLLLLL”, and hence the adjustment section 104 adds “−1” to the digital value stored in the storage section 101.

As described above, the adjustment section does not update the digital value if the voltage value of the analog signal is near the reference voltage value Vref, because the determination results by the determination section 103 are unstable at this time. Occurrence of ringing can therefore be suppressed. Also, since the processing by the determination section 103 and the adjustment section 104 is continued, the input/output characteristics of the correlated double sampling circuit can be controlled appropriately even when the offset voltage of the correlated double sampling circuit fluctuates.

The thresholds (n and m) of the determination results may be set according to the surrounding environment of the imaging device and the precision and characteristics of the image sensor circuit and the correlated double sampling circuit.

### Embodiment 3

The clamp circuit 11 of Embodiment 3 of the present invention is the same in configuration as that shown in FIG. 1, but is different therefrom in the processing by the determination section 103 and the processing by the adjustment section 104.

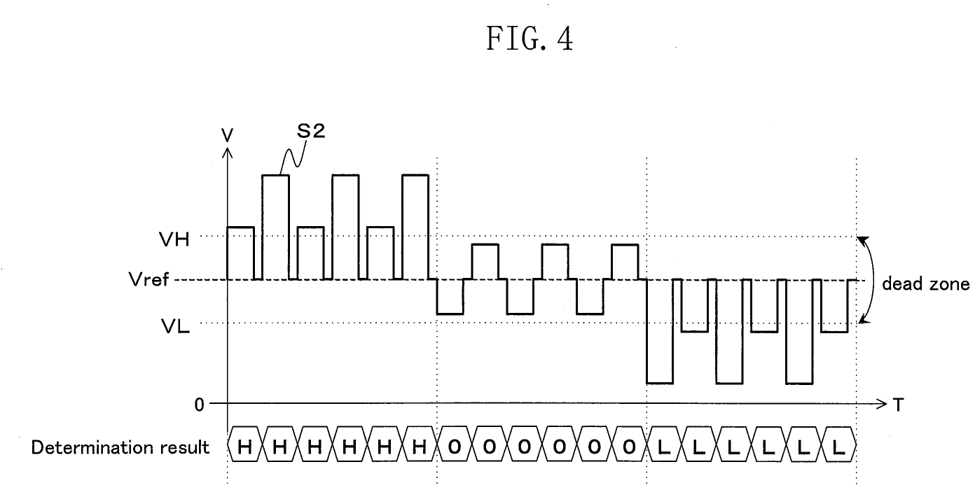

In this embodiment, the determination section 103 defines a range near the reference voltage value as a dead zone. In other words, as shown in FIG. 4, the determination section 103 has voltage values VH and VL set according to the voltage value of the reference voltage (reference voltage value Vref) supplied from the reference voltage generation circuit 12, so that the range for determination by the determination section 103 is divided into three voltage ranges with the two voltage values. The voltage value VH is a voltage value higher than the reference voltage value Vref by a predetermined amount, and the voltage value VL is a voltage value lower than the reference voltage value Vref by the predetermined amount. The determination section 103 outputs “H” if the voltage value of the analog signal S2 is higher than the voltage value VH, outputs “L” if it is lower than the voltage value VL, and outputs “0” (determination result indicating being void) if it is somewhere between the voltage value VH and the voltage value VL.

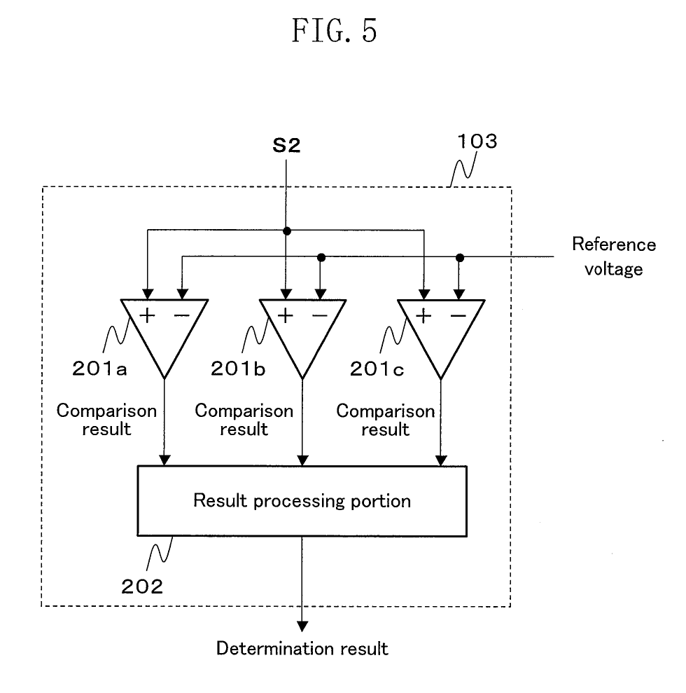

FIG. 5 shows an example of the configuration of the determination section 103 in this embodiment. The determination section 103 includes a plurality of comparators (three comparators in the illustrated example) 201a, 201b, and 201c and a result processing portion 202.

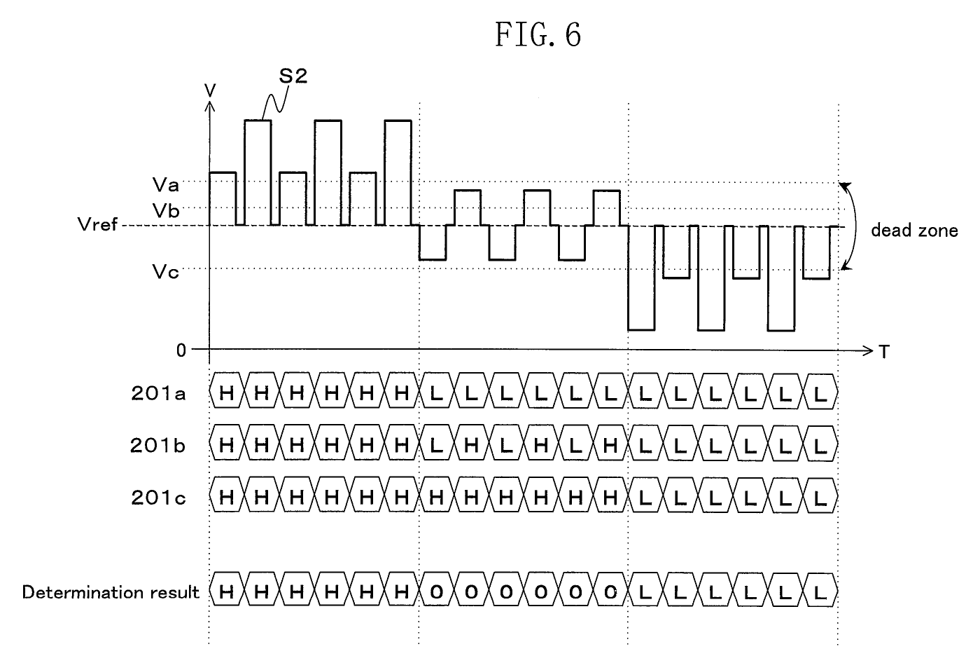

Each of the plurality of comparators 201a, 201b, and 201c receives the analog signal S2 from the correlated double sampling circuit 2, and outputs “H” if determining that the voltage value of the analog signal S2 is greater than the reference voltage value and outputs “L” if determining that the voltage value of the analog signal S2 is smaller than the reference voltage value. Since the comparators 201a, 201b, and 201c have fabrication variations, the comparison results by these comparators will be different from one another if the difference between the voltage value of the analog signal S2 and the reference voltage value Vref is minute. In other words, as shown in FIG. 6, the thresholds (thresholds for determining whether the voltage value of the analog signal S2 is higher or lower than the reference voltage value Vref) of the comparators 201a, 201b, and 201c, which are respectively denoted by “Va”, “Vb”, and “Vc”, do not agree with one another. Hence, when the voltage value of the analog signal S2 is somewhere between the threshold Va of the comparator 201a and the threshold Vc of the comparator 201C, the comparison results from the comparators 201a, 201b, and 201c do not agree with one another.

The result processing portion 202 outputs “H” if the comparison results from the comparators 201a, 201b, and 201c are all “H”, outputs “L” if they are all “L”, and outputs “0” (determination result indicating being void) if the comparison results do not agree with one another. In other words, in the determination section 103 shown in FIG. 5, the range between the thresholds Va and Vc serves as the dead zone.

In this embodiment, the adjustment section 104 adds a positive value to the digital value stored in the storage section 101 if the “H” count (the number of times the voltage value of the analog signal S2 is determined higher than the voltage value VH) is greatest among the k determination results by the determination section 103, adds a negative value to the digital value if the “L” count (the number of times the voltage value of the analog signal S2 is determined lower than the voltage value VL) is greatest, and does not update the digital value if the “0” count (the number of times the determination of being void is made) is greatest. If there are same counts of determination results (e.g., the “H” count and the “L” count are the same), it is preferred for the adjustment section 104 not to update the digital value.

As described above, when the voltage value of the analog signal is near the reference voltage value, the number of times the determination section makes the determination of being void increases. Hence, the adjustment section does not update the digital value. In this way, occurrence of ringing can be suppressed.

### Embodiment 4

The clamp circuit of Embodiment 4 of the present invention is the same in configuration as that shown in FIG. 1, but is different therefrom in the processing by the determination section 103 and the processing by the adjustment section 104.

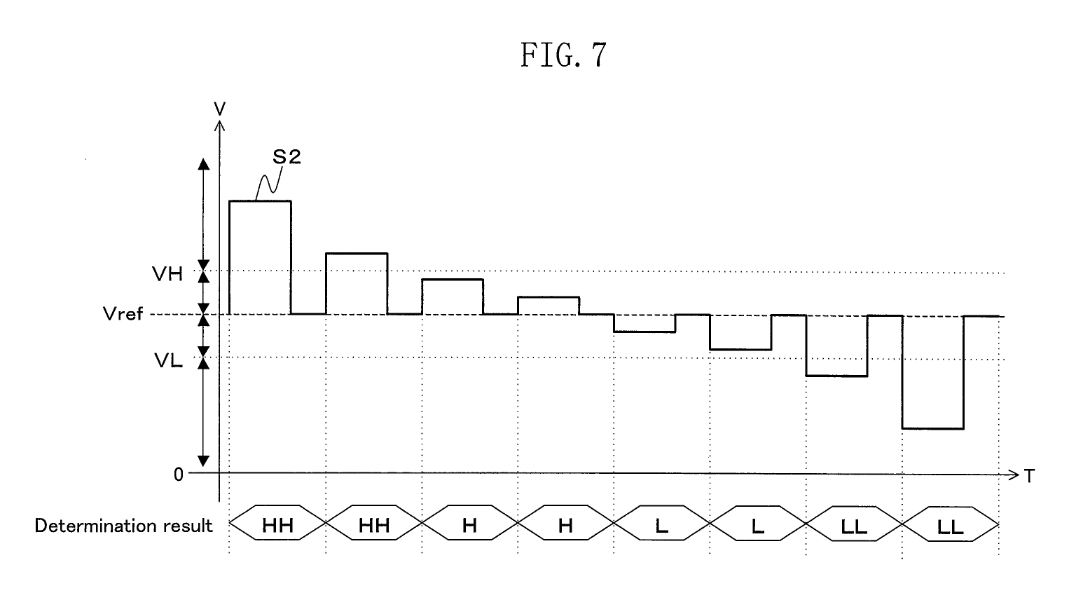

In the clamp circuit of this embodiment, the determination section 103 outputs 2-bit determination results. In other words, as shown in FIG. 7, the determination section 103 has the voltage value of the reference voltage (reference voltage value Vref) supplied from the reference voltage generation circuit 12 and voltage values VH and VL set according to the reference voltage value Vref, so that the range of determination by the determination section 103 is divided into four voltage ranges with the three voltage values. The determination section 103 determines to which voltage range the voltage value of the analog signal S2 belongs. For example, the determination section 103 outputs “HH” if the voltage value of the analog signal S2 belongs to the range higher than the voltage value VH.

In this embodiment, the adjustment section 104 has a dead zone; i.e., the adjustment section 104 adds a positive value to the digital value if the “HH” count (the number of times the voltage value of the analog signal S2 is determined belonging to the range higher than the voltage value VH) is greatest among a plurality of determination results by the determination section 103, adds a negative value to the digital value if the “LL” count (the number of times the voltage value of the analog signal S2 is determined belonging to the range lower than the voltage value VL) is greatest, and does not update the digital value if the “H” count or the “L” count is greatest.

As described above, when the voltage value of the analog signal is near the reference voltage value, the “H” count or the “L” count increases among the determination results by the determination section. Hence, the adjustment section does not update the digital value. In this way, occurrence of ringing can be suppressed.

### Embodiment 5

The clamp circuit 11 of Embodiment 5 of the present invention is the same in configuration as that shown in FIG. 1, but is different therefrom in the processing by the determination section 103 and the processing by the adjustment section 104.

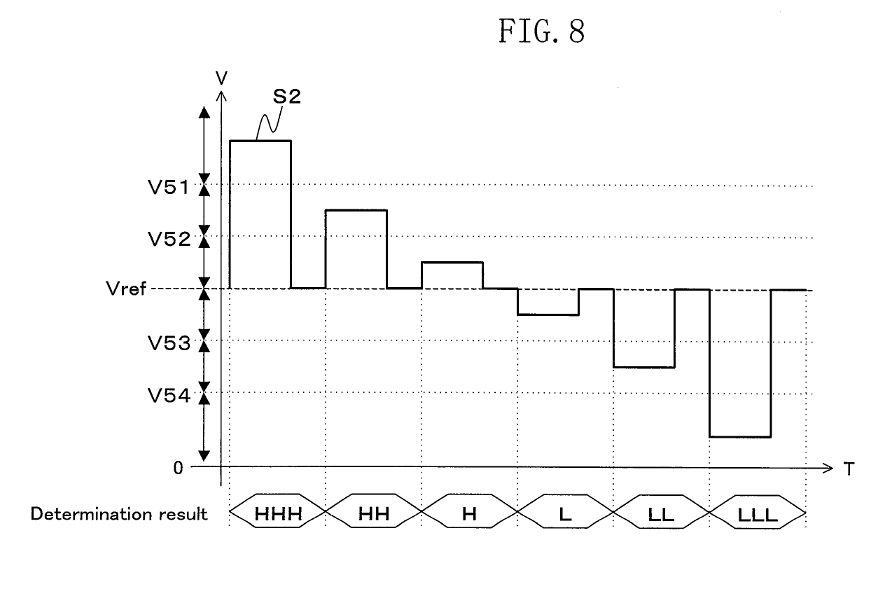

In the clamp circuit 11 of this embodiment, the determination section 103 outputs n-bit determination results. In other words, as shown in FIG. 8, the determination section 103 has the voltage value of the reference voltage (reference voltage value Vref) supplied is from the reference voltage generation circuit 12 and voltage values V51, V52, V53, and V54, so that the range of determination by the determination section 103 is divided into six voltage ranges with the five voltage values. As in Embodiment 3, the determination section 103 determines to which voltage range the voltage value of the analog signal S2 belongs. For example, the determination result “H” indicates that the voltage value of the analog signal S2 belongs to the range between the voltage value V52 and the reference voltage value Vref, and the determination result “L” indicates that the voltage value of the analog signal S2 belongs to the range between the reference voltage value Vref and the voltage value V53.

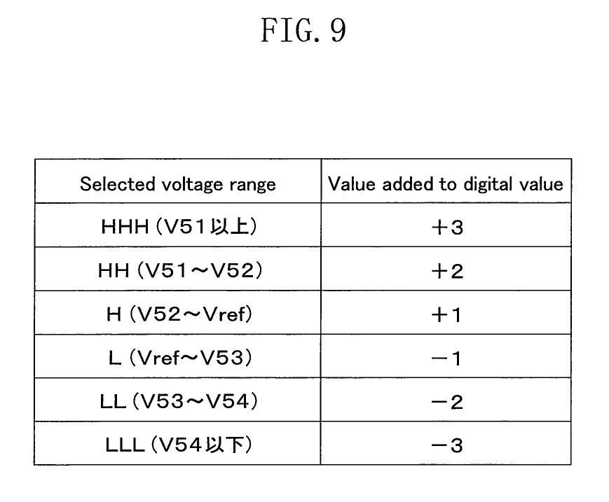

The adjustment section 104 selects, among voltage ranges indicated by the k determination results by the determination section 103, a voltage range indicated by the largest number of determination results, and adds a value corresponding the selected voltage range to the digital value. As shown in FIG. 9, the adjustment section 104 adds a positive value to the digital value if the selected voltage range is higher than the reference voltage value Vref, adds a negative value to the digital value if the selected voltage range is lower than the reference voltage value Vref. Also, as the difference between the selected voltage and the reference voltage value Vref is greater, the value added to the digital value by the adjustment section 104 is greater. Fore example, when the number of determination results indicating “HHH” is greatest among the k determination results by the determination section 103, the adjustment section 104 adds “+3” to the digital value stored in the storage section 101.

As described above, by increasing the value added to the digital value as the difference between the voltage value of the analog signal and the reference voltage value increases, the voltage value of the analog signal can be quickly made close to the reference voltage value.

As in Embodiment 4, a dead zone may be provided for the adjustment section 104; i.e., the adjustment section 104 may be configured not to update the digital value stored in the storage section 101 when the number of determination results indicating a voltage range including the reference voltage value Vref (“H” and “L” in FIG. 9) is greatest among the k determination results by the determination section 103. With this configuration, occurrence of ringing can be suppressed.

### Other Embodiments

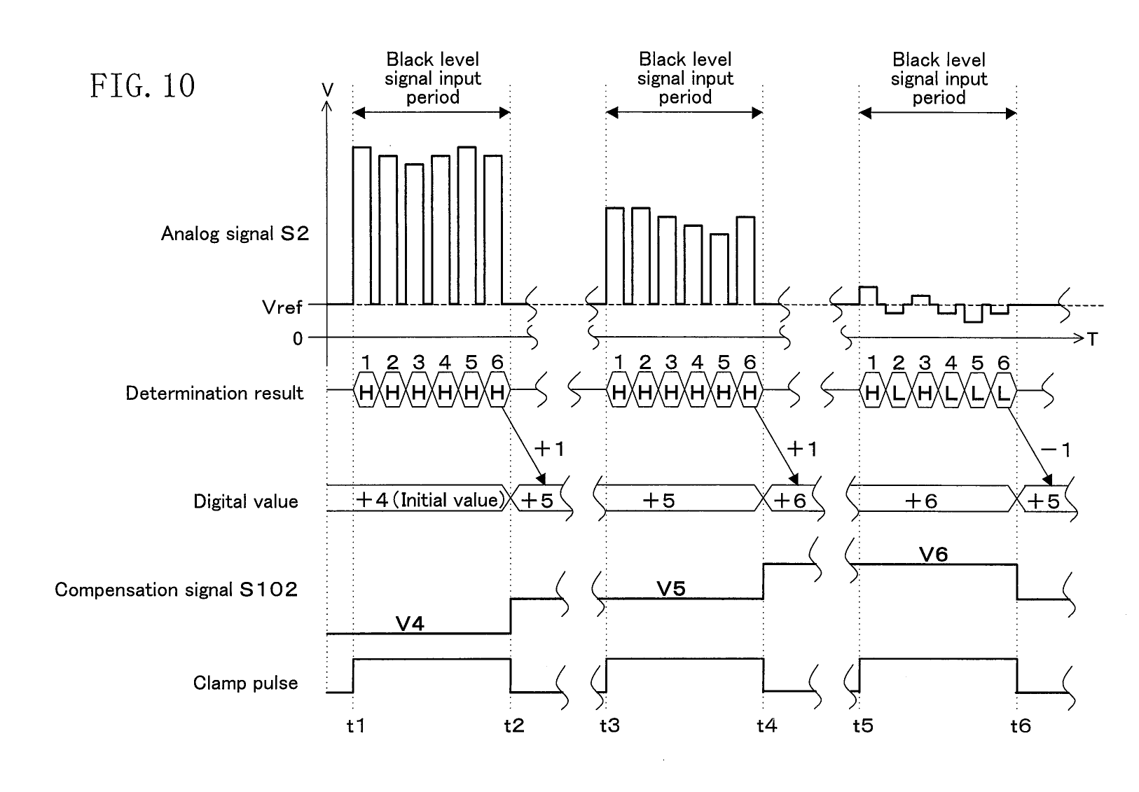

As shown in FIG. 10, the processing by the determination section 103 and the processing by the adjustment section 104 may be executed over a plurality of black level signal input periods. For example, the digital value may be updated once every horizontal as line on the imaging plane of the image sensor circuit 1.

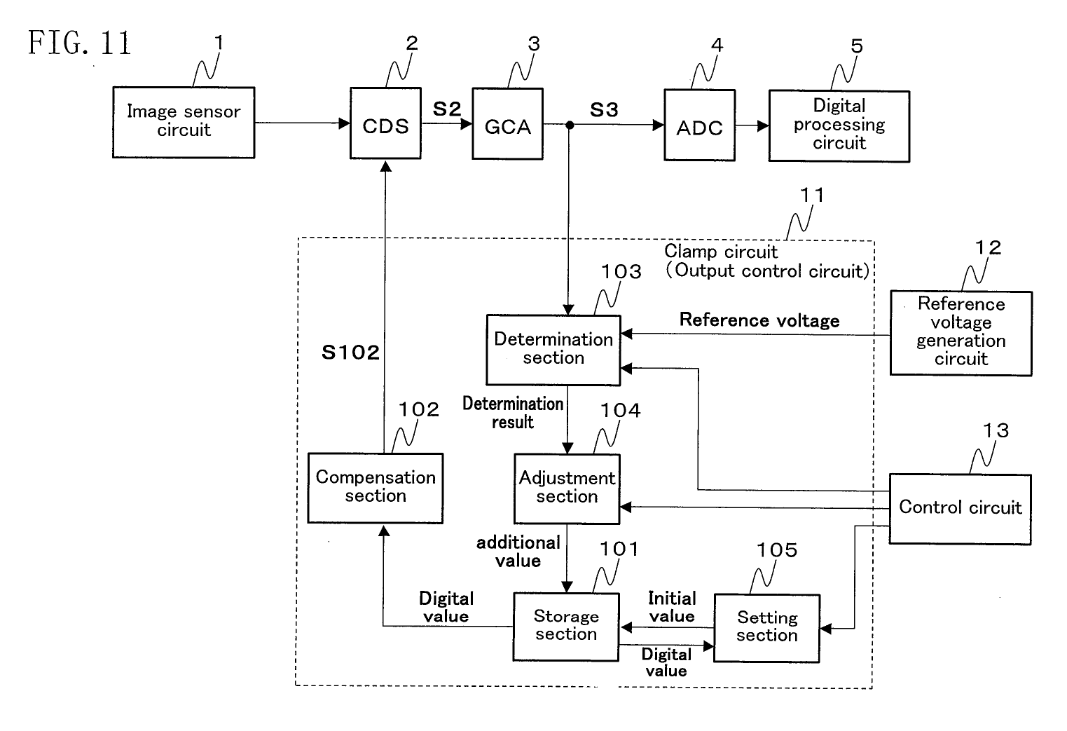

As another embodiment, as shown in FIG. 11, the offset voltage of the correlated double sampling circuit 2 may be compensated based on an analog signal S3 from the gain control amplifier circuit 3. In this case, the clamp circuit 11 controls the input/output characteristics of the correlated double sampling circuit 2 so that the voltage value of an analog signal outputted from the gain control amplifier circuit 3 becomes the reference voltage value when an analog signal corresponding to a black level signal is inputted into the gain control amplifier circuit 3.

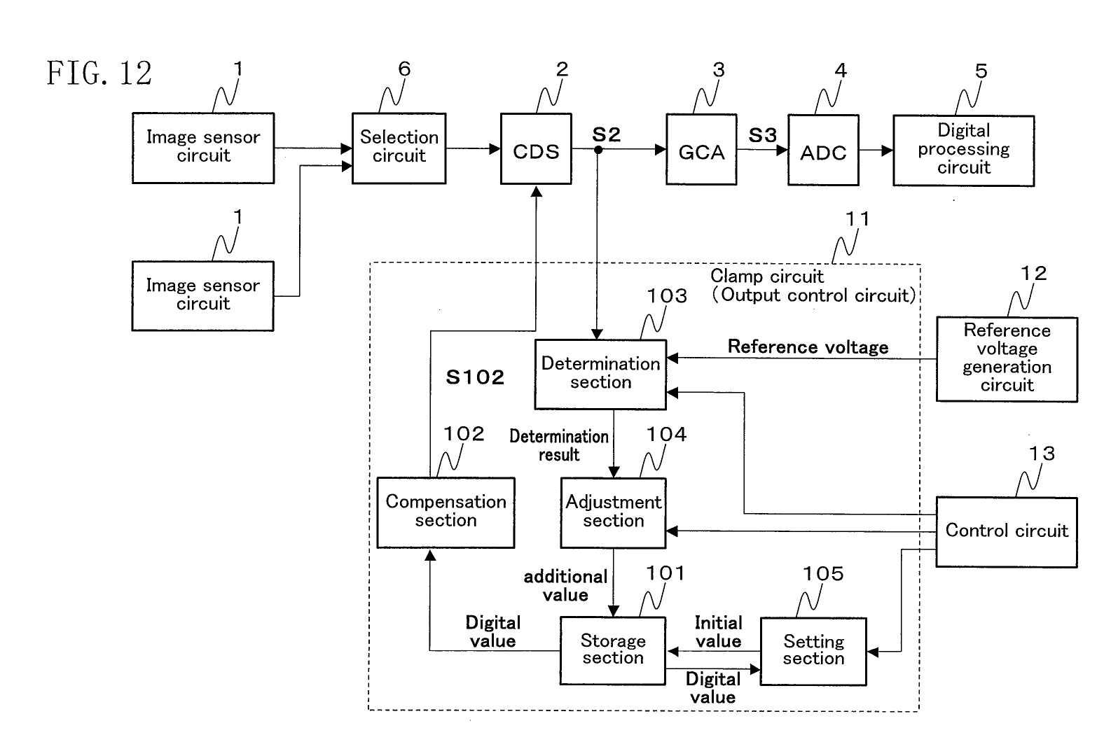

As yet another embodiment, as shown in FIG. 12, an imaging device equipped with a plurality of image sensor circuits 1 can be configured. In FIG. 12, the imaging device includes another image sensor circuit 1 and a selection circuit 6 in addition to the components in FIG. 1. The selection circuit 6 selects either one of the two image sensors 1 and supplies an electric signal from the selected image sensor circuit 1 to the correlated double sampling circuit 2. The setting section 105 of the clamp circuit 11 stores initial values for the two image sensor circuits 1. Under the control of the control circuit 13, the is setting section 105 selects one, out of the two initial values, which corresponds to the image sensor circuit 1 selected by the selection circuit 6, and sets the digital value stored in the storage section 101 at the selected initial value.

With the above configuration, in which it is unnecessary to provide the analog front end circuits (the correlated double sampling circuit, the gain control amplifier circuit, and the analog/digital converter circuit) for each image sensor circuit, the circuit scale and the power consumption can be reduced. Moreover, since the initial value for the digital value can be set for each image sensor circuit, switching of the image sensor circuits can be made smoothly.

In the embodiments described above, a clamp circuit mounted in an imaging device has been described. The output control circuit of the present invention is not limited to this, but is applicable as a circuit for controlling the input/output characteristics of an amplifier circuit having an offset voltage that is adjustable.

### INDUSTRIAL APPLICABILITY

As described above, the output control circuit according to the present invention is useful as a clamp circuit mounted in an imaging device for a digital camera, a mobile phone, a miniature camera for medical use, and the like, a circuit for controlling the input/output characteristics of an amplifier circuit having an offset voltage that is adjustable, and the like.

1. A circuit for controlling input/output characteristics of an amplifier circuit having an offset voltage that is adjustable, comprising:
a storage section configured to store a digital value for determining a compensation amount for the offset voltage;
a compensation section configured to reduce the voltage value of the offset voltage of the amplifier circuit as the digital value stored in the storage section increases;
a determination section configured to determine whether the voltage value of an analog output signal from the amplifier circuit is higher or lower than a reference voltage value; and
an adjustment section configured to, once receiving k determination results (k is a natural number equal to or more than 2) by the determination section, add a positive value to the digital value stored in the storage section if the number of times the voltage value of the analog output signal is determined higher than the reference voltage value among the k determination results is greater than the number of times the voltage value of the analog output signal is determined lower than the reference voltage value, and add a negative value to the digital value stored in the storage section if the number of times the voltage value of the analog output signal is determined lower than the reference voltage value is greater than the number of times the voltage value of the analog output signal is determined higher than the reference voltage value.

2. The output control circuit of claim 1, wherein the adjustment section adds the positive value to the digital value if the number of times the voltage value of the output signal is determined higher than the reference voltage value among the k determination results is equal to or more than n (n>(k/2)), and adds the negative value to the digital value if the number of times the voltage value of the output signal is determined lower than the reference voltage value among the k determination results is equal to or more than m (m>(k/2)).

3. The output control circuit of claim 1, wherein the determination section makes determination of being void if the voltage value of the output voltage belongs to a voltage range defined by a first voltage value higher than the reference voltage value and a second voltage value lower than the reference voltage value, and
the adjustment section adds the positive value to the digital value if the number of times the voltage value of the output signal is determined higher than the first voltage value is greatest among the k determination results, adds the negative value to the digital value if the number of times the voltage value of the output signal is determined lower than the second voltage value is greatest among the k determination results, and does not update the digital value if the number of times the determination of being void is made is greatest among the k determination results.

4. The output control circuit of claim 1, wherein the determination section includes:
a plurality of comparators configured to receive the output signal from the amplifier circuit in parallel and compare whether the voltage value of the output signal is higher or lower than the reference voltage value; and
a result processing portion configured to output a comparison result as the determination result if all of the plurality of comparators output the same comparison result, and output a determination result indicating being void if the plurality of comparators output different comparison results from each other.

5. The output control circuit of claim 1, wherein the determination section determines to which one of three voltage ranges divided with a first voltage value higher than the reference voltage value and a second voltage value lower than the reference voltage value the voltage value of the output signal belongs, and
the adjustment section selects a voltage range indicated by the largest number of determination results among voltage ranges indicated by the k determination results, adds the positive value to the digital value if the selected voltage range is a range higher than the first voltage value, adds the negative value to the digital value if the selected voltage range is a range lower than the second voltage value, and does not update the digital value if the selected voltage range is a range between the first voltage value and the second voltage range.

6. The output control circuit of claim 1, wherein the determination section determines to which one of a plurality of voltage ranges divided with a plurality of voltage values including the reference voltage value the voltage value of the output signal belongs, and
the adjustment section selects a voltage range indicated by the largest number of determination results among voltage ranges indicated by the k determination results, adds the positive value to the digital value if the selected voltage range is a range higher than the reference voltage value, adds the negative value to the digital value if the selected voltage range is a range lower than the reference voltage value, and increases the value added to the digital value as the difference between the median of the selected voltage range and the reference voltage value increases.

7. The output control circuit of claim 6, wherein the adjustment section does not update the digital value if the selected voltage range is a voltage range including the reference voltage value among the plurality of voltage ranges.

8. The output control circuit of claim 1, further comprising a setting section configured to store an initial value of the digital value and set the digital value stored in the storage section at the initial value.

9. The output control circuit of claim 8, wherein the setting section further reads the digital value stored in the storage section and stores the read digital value as the initial value.

10. The output control circuit of claim 1, wherein the amplifier circuit includes a signal output section having an offset voltage that is adjustable and an amplifier section configured to amplify the output from the signal output section,
the determination section receives an output signal from the amplifier section, and
the compensation section compensates the offset voltage of the signal output section.

11. An imaging device comprising:
the output control circuit of claim 1;
a first image sensor circuit having an imaging plane with a plurality of light-receiving pixels and a plurality of optical black pixels formed thereon, the first image sensor converting an image of a subject to an electric signal;
a correlated double sampling circuit having an offset voltage that is adjustable, the correlated double sampling circuit extracting an analog signal representing a luminance signal from the electric signal obtained by the first image sensor circuit;
an amplifier circuit configured to amplify the analog signal from the correlated double sampling circuit;
an analog/digital converter circuit configured to convert the analog signal amplified by the amplifier circuit to a digital signal; and
a digital processing circuit configured to perform digital processing for the digital signal obtained by the analog/digital converter circuit,
wherein the output control circuit is a clamp circuit configured to control the input/output characteristics of the correlated double sampling circuit,
the determination section determines whether the voltage value of an analog signal corresponding to the optical black pixel, in the analog signal from the correlated double sampling circuit, is higher or lower than the reference voltage value; and
the compensation section compensates the offset voltage of the correlated double sampling circuit.

12. An imaging device comprising:
the output control circuit of claim 1;
a first image sensor circuit having an imaging plane with a plurality of light-receiving pixels and a plurality of optical black pixels formed thereon, the first imaging sensor converting an image of a subject to an electric signal;
a correlated double sampling circuit having an offset voltage that is adjustable, the correlated double sampling circuit extracting an analog signal representing a luminance signal from the electric signal obtained by the first image sensor circuit;
an amplifier circuit configured to amplify the analog signal from the correlated double sampling circuit;
an analog/digital converter circuit configured to convert the analog signal amplified by the amplifier circuit to a digital signal; and
a digital processing circuit configured to perform digital processing for the digital signal obtained by the analog/digital converter circuit,
wherein the output control circuit is a clamp circuit configured to control the input/output characteristics of the correlated double sampling circuit,
the determination section determines whether the voltage value of an analog signal corresponding to the optical black pixel, in the analog signal from the amplifier circuit, is higher or lower than the reference voltage value; and
the compensation section compensates the offset voltage of the correlated double sampling circuit.

13. The imaging device of claim 11, further comprising:
a second image sensor circuit having an imaging plane with a plurality of light-receiving pixels and a plurality of optical black pixels formed thereon, the second image sensor circuit converting an image of a subject to an electric signal; and
a selection circuit configured to select either one of the first and second image sensor circuits and supply an electric signal from the selected image sensor circuit to the correlated double sampling circuit,
wherein the output control circuit further includes a setting section for storing initial values corresponding to the first and second image sensor circuits and setting the digital value stored in the storage section at the initial value corresponding to the selected image sensor circuit.

14. The output control circuit of claim 2, wherein the adjustment section does not update the digital value if the number of times the voltage value of the output signal is determined higher than the reference voltage value among the k determination results is smaller than n and the number of times the voltage value of the output signal is determined lower than the reference voltage value is smaller than m.

15. A circuit for controlling input/output characteristics of an amplifier circuit having an offset voltage that is adjustable, comprising:
a storage section configured to store a digital value for determining a compensation amount for the offset voltage;
a compensation section configured to reduce the voltage value of the offset voltage of the amplifier circuit as the digital value stored in the storage section increases;
a determination section configured to determine whether the voltage value of an output signal from the amplifier circuit is higher or lower than a reference voltage value; and
an adjustment section configured to, once receiving k determination results (k is a natural number equal to or more than 2) by the determination section, add a positive value to the digital value if the number of times the voltage value of the output signal is determined higher than the reference voltage value among the k determination results is equal to or more than n (n>(k/2)), and add a negative value to the digital value if the number of times the voltage value of the output signal is determined lower than the reference voltage value among the k determination results is equal to or more than m (m>(k/2)).

16. The output control circuit of claim 15, wherein the adjustment section does not update the digital value if the number of times the voltage value of the output signal is determined higher than the reference voltage value among the k determination results is smaller than n and the number of times the voltage value of the output signal is determined lower than the reference voltage value is smaller than m.
